(19) United States
(12) Patent Application Publication
(10) Pub. No.: US 2005/0021894 A1
(43) Pub. Date: Jan. 27, 2005

(54) Method and system for interrupt mapping

(75) Inventors: Kevin Traynor, Cary, NC (US); Jon Brabender, Cary, NC (US)

Correspondence Address: Burns, Doane, Swecker & Mathis, L.L.P., P.O. Box 1404, Alexandria, VA, 22313-1404, US

(73) Assignee: Renesas Technology America, Inc.

(21) Appl. No.: 10/626,756

(22) Filed: Jul. 24, 2003

(51) Int. Cl. G06F 13/24

(52) U.S. Cl. 710/262

(57) ABSTRACT

A method and system are described for sharing a plurality of interrupt inputs associated with a processor among a plurality of interrupt sources. Each of the plurality of interrupt sources is mapped to each of the plurality of interrupt inputs. Interrupt requests from each of the plurality of interrupt sources to one or more of the plurality of interrupt inputs are selectively enabled, e.g., via control bits. The control bits are preferably dynamically modifiable according to user preferences.

### BACKGROUND

The invention relates to controlling the operation of processors. More particularly, the invention relates to the sharing of a limited number of interrupt inputs associated with the processor among multiple input sources.

A “microcontroller unit” or “MCU” is typically a single chip that contains a processor, random access memory (RAM), read only memory (ROM), a clock and an input/output (I/O) control unit. Hundreds of millions of them are used each year for a variety of product applications ranging from automobiles to toys. The versatility of MCUs provides a product designer with the opportunity to add a variety of functions to the products that can be tailored to the specific product application. This versatility is realized through programming of the MCU. The program is typically stored in a nonvolatile memory, i.e., the ROM.

At the heart of the MCU is the processor. A processor executes the program routines, which each comprise sets of instructions to be carried out. A processor's current program routine execution may be interrupted upon the receipt of one or more interrupt requests, which prompt the processor to leave the routine to perform a task with a higher priority and, in most cases, to then resume the original routine. These interrupts can be in response to internal signals such as from a timer, a counter, a reset module or from external interrupt sources, such as a signal from an I/O device, such as a sensor. Typically, an interrupt vector table in memory stores an address for each interrupt request for branching to an appropriate interrupt service routine. The interrupt service routines are the sets of instructions to be carried out by the processor in response to the interrupts.

An interrupt controller (IC) is typically used in conjunction with the processor to receive interrupt requests and place interrupt requests into a hierarchy according to priority. If an interrupt request at a certain priority level in the hierarchy is being serviced, then that servicing cannot be interrupted by requests at the same priority level or lower. Requests for interrupts that are at higher priority levels in the hierarchy may suspend the servicing of interrupts at lower priority levels. The interrupt controller is typically integrated within an MCU, for example as part of the I/O control unit, to handle interrupt request processing for the MCU.

The IC can accommodate only a limited number of interrupt sources due to hardware and/or software constraints. An interrupt source sends an interrupt request signal to the IC through logical, or physical, interrupt request paths, referred to here as interrupt inputs. A mismatch occurs when the number of interrupt sources is greater than the number of interrupt inputs available. Conventional methods of sharing interrupt inputs between multiple interrupt sources are limited.

One conventional method is illustrated in FIG. 1. Multiple interrupt sources 100 are logically “ORed” together through an OR gate 110 to an interrupt input. This arrangement has several drawbacks. One drawback is that all of the ORed interrupt sources are always logically connected to the same interrupt input. That is, an interrupt source cannot be blocked (or disabled) from reaching the interrupt controller through programming under the control of an end user without blocking all of the ORed interrupt sources. Another drawback is that the interrupt controller and processor must first determine which interrupt source 100 is issuing the interrupt request. This is typically done by polling the associated interrupt sources. Still another drawback is that an interrupt source cannot be mapped to more than one interrupt input.

Another conventional method is illustrated in FIG. 2. Two (or more) interrupt sources 200, 205 are multiplexed together through a multiplexer 220 to an interrupt input. The value of a select control bit (or bits) 210 is set to select one of the interrupt sources 200, 205 as active at a particular point in time. Using this arrangement, one (or more) non-selected interrupt source must have its interrupt requests blocked from reaching the interrupt controller. That is, there is no provision for allowing both interrupt sources to be active simultaneously. Another drawback is that an interrupt source cannot be mapped to more than one interrupt input.

A need therefore exists for a system and method for interrupt sharing that provides for each of the interrupt sources to be logically mapped to multiple interrupt inputs and that provides for the user selectable enabling and disabling of each of the interrupt sources.

### SUMMARY

It should be emphasized that the terms “comprises” and “comprising”, when used in this description and claims, are taken to specify the presence of stated features, steps, or components, but the use of these terms does not preclude the presence or addition of one or more other features, steps, components, or groups thereof.

In one aspect of the invention, a method is disclosed for sharing a plurality of interrupt inputs associated with a processor among a plurality of interrupt sources. Each of the plurality of interrupt sources is mapped to each of the plurality of interrupt inputs. Interrupt requests from each of the plurality of interrupt sources to one or more of the plurality of interrupt inputs are selectively enabled.

In another aspect of the invention, a system is disclosed for sharing a plurality of interrupt inputs associated with a processor among a plurality of interrupt sources. The system comprises logic that maps each of the plurality of interrupt sources to each of the plurality of interrupt inputs and logic that selectively enables interrupt requests from each of the plurality of interrupt sources to one or more of the plurality of interrupt inputs.

In yet another aspect of the invention, a system is disclosed for sharing a plurality of interrupt inputs associated with a processor among a plurality of interrupt sources. The system comprises, for each interrupt input, a plurality of logical ANDs, each corresponding to an interrupt source, the corresponding interrupt source providing an interrupt request signal to the corresponding logical AND to interrupt the processor. A plurality of control bits each correspond to an interrupt source and each respectively provide a control bit value to the corresponding logical AND, wherein, based on the control bit value, a corresponding interrupt request signal is provided at an output of the corresponding logical AND. A logical OR is arranged to indicate, to the interrupt input, the presence of a corresponding interrupt request signal from at least one output of the plurality of logical ANDs.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating a conventional interrupt input sharing arrangement.

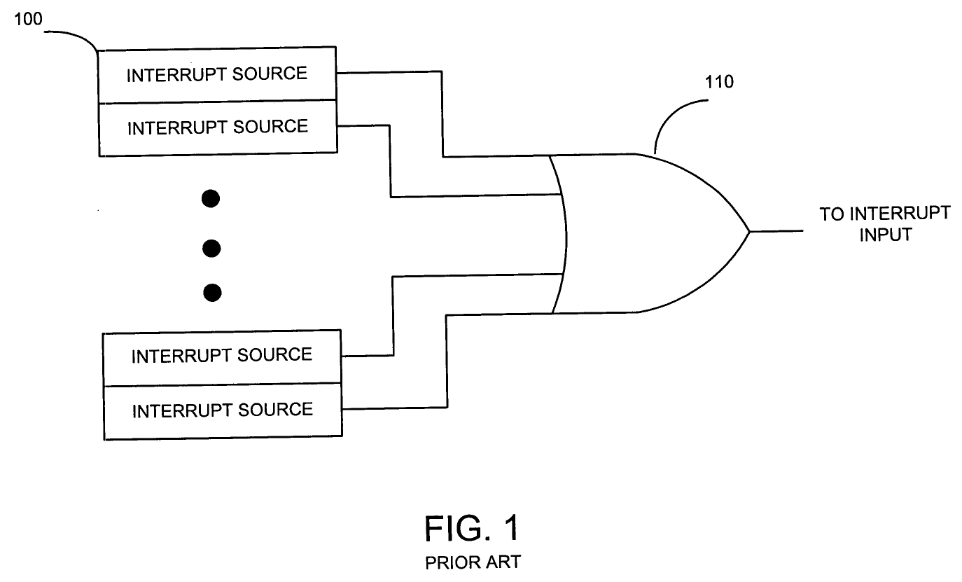

FIG. 2 is a block diagram illustrating another conventional interrupt input sharing arrangement.

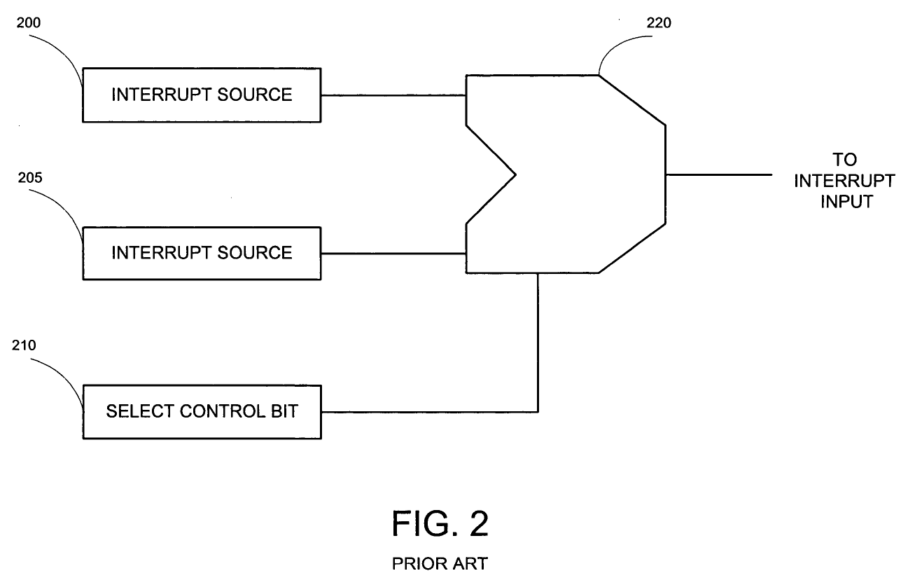

FIG. 3 is a block diagram illustrating a system for interrupt mapping according to an aspect of the invention.

FIG. 4 is a flowchart illustrating a method for interrupt mapping according to an aspect of the invention.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer readable medium for use by or in connection with an instruction execution system, apparatus, or device, such as a computer based system, processor containing system, or other system that can fetch the instructions from a medium and execute the instructions.

As used herein, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

Thus, the invention can be embodied in many different forms, and all such forms are contemplated to be within the scope of what is claimed. Any such form of embodiment can be referred to herein as “logic configured to” perform a described action, or alternatively as “logic that” performs a described action.

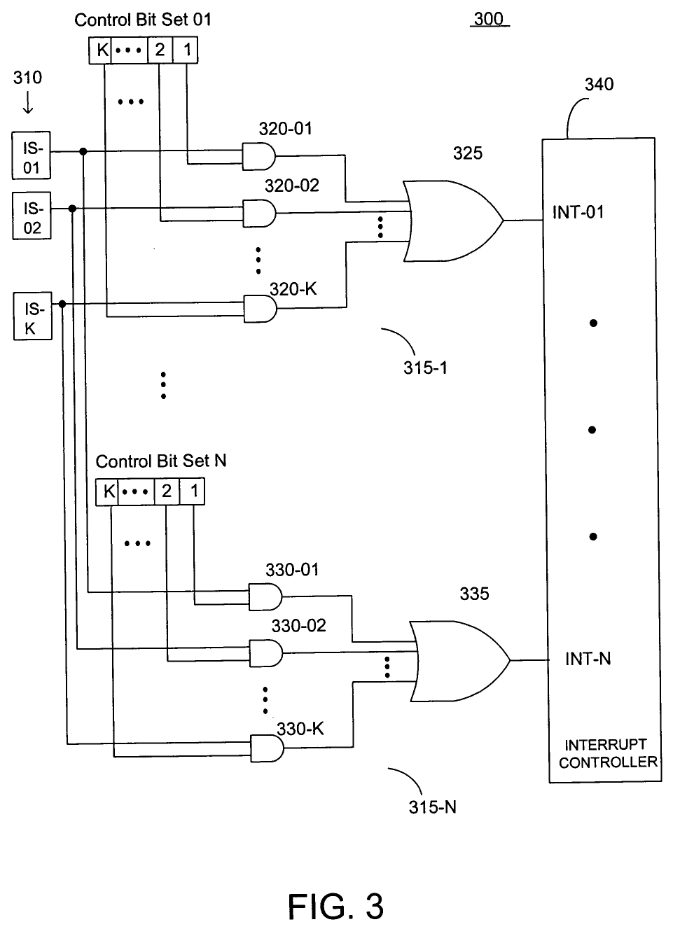

A system for interrupt mapping 300 according to an aspect of the invention is illustrated in FIG.3. A number K of interrupt sources 310, namely IS-01 through IS-K, are each mapped to a number N of interrupt inputs, namely INT-01 through INT-N, on an IC 340 associated with one or more processors (not shown). The system comprises N logical mapping subsets (LMS), 315-1 through 315-N, each corresponding to one of the interrupt inputs, INT-01 through INT-N.

Each LMS, 315-1 through 315-N, includes K logical ANDs and a logical OR. For example, the LMS 315-1 includes logical ANDs 320-1 through 320-K, each having their outputs logically connected to logical OR 325. Likewise, the LMS 315-N includes logical ANDs 330-1 through 330-K, each having their outputs logically connected to logical OR 335.

Each LMS, 315-1 through 315-N, also includes a corresponding control bit set (CBS) of K bits. For example, the LMS 315-1 includes a corresponding CBS 01 and the LMS 315-N includes a corresponding CBS N. Bits 1 to K of each CBS are each logically connected to one input of a corresponding logical AND in the associated LMS. For example, bit 1 of CBS 01 is logically connected to logical ANDs 320-1, bit 2 of CBS 01 is logically connected to logical ANDs 320-2, and so on.

The input sources, IS-01 through IS-K, are each logically connected to the other input of each corresponding logical AND in each of the LMSs, 315-1 through 315-N. For example, IS-01 is logically connected to logical ANDs 320-1 and 330-1, in addition to the other LMSs that are not shown.

The system 300 of FIG. 3 is therefore arranged to provide mapping between any of the K interrupt sources 310, IS-01 through IS-K, and any one or more of the interrupt inputs, INT-01 through INT-N, of the interrupt controller 340. An interrupt request from an interrupt source 310 to any one or more interrupt inputs, INT-01 through INT-N, is selectively enabled by setting the value of the corresponding bit in the respective CBS to enable/disable the receipt of interrupt requests from the interrupt source 310. For example, interrupt source IS-02 is mapped to interrupt input INT-01 through logical AND 320-2 and logical OR 325 such that control bit 2 of CBS 01 enables/disables the receipt of interrupt requests at interrupt input INT-01. Likewise, interrupt source IS-02 is mapped to interrupt input INT-N through logical AND 330-2 and logical OR 335 such that control bit 2 of CBS N enables/disables the receipt of interrupt requests at interrupt input INT-N. Interrupt source IS-02 may be mapped to the rest of the interrupt inputs (not shown) similarly through the respective other LMSs (not shown).

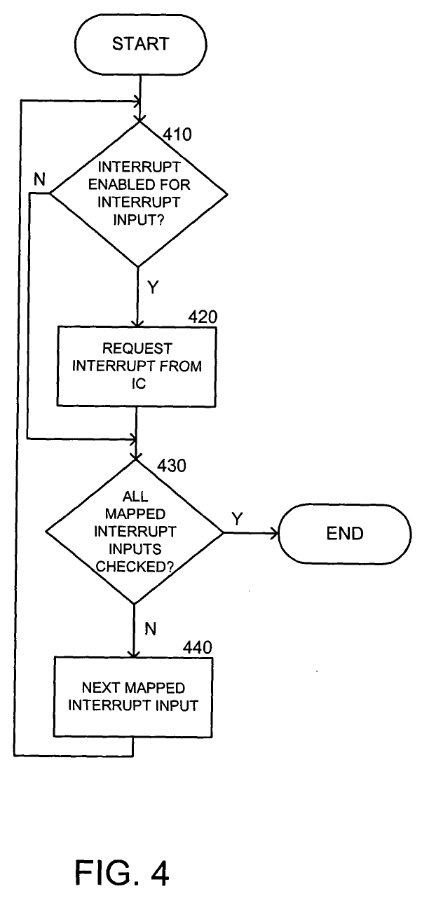

A method for interrupt mapping according to an aspect of the invention is illustrated in FIG. 4. When an interrupt request is received from an interrupt source 310, the corresponding control bit value setting is determined for the first mapped interrupt input to determine if interrupt requests from the interrupt source 310 are enabled for the respective interrupt input (step 410). If interrupt requests are enabled, an interrupt is requested from the IC 340 at that interrupt input (step 420). If, however, interrupt requests are disabled, the interrupt request is blocked from reaching that interrupt input of the IC 340. In either case, the system then determines if all interrupt inputs mapped to the interrupt source have been checked (step 430), and if not, the process repeats for the next mapped interrupt input (step 440). Once all mapped interrupt inputs are checked (step 430) the system awaits another interrupt request.

The CBS bit values may be user-definable, defined by system demands, or a combination of the two, and are preferably modifiable during operation, i.e., dynamically modifiable. The CBS values are maintained in a memory, such as a register, which is accessible to the processor. Although each CBS is shown sized for each LMS, it should be understood that a CBS may be broken into smaller subsets or multiple CBSs may be combined to form a larger bit set that is associated with multiple LMSs.

The interrupt mapping system 300 and method provides the ability to map any interrupt source 310 to any one or more interrupt inputs, INT-01 through INT-N. Moreover, the interrupt request routing through the mapping can be changed by an end user dynamically. An even greater benefit is realized when the system 300 or method is employed to map a number of interrupt sources 310 to a lesser number of interrupt inputs, i.e., when K>N, although this is not a requirement. In such a case, the system 300 and method provide an interrupt sharing function, in addition to the mapping and interrupt request routing functions.

The added flexibility afforded through mapping provides many advantages over conventional interrupt-sharing arrangements. Consider, for example, where the IC 340 has assigned priorities to each of the interrupt inputs INT-01 through INT-N. The priority of an interrupt source 310 can be changed dynamically (and repeatedly) by setting the associated control bits to enable requests to be mapped only to the interrupt input having the desired priority level. Moreover, the set of enabled interrupt sources 310 can be changed dynamically according to user preferences, system state, system demands, or a host of other conditions.

It will be appreciated by those of ordinary skill in the art that the invention can be embodied in various specific forms without departing from its essential characteristics. The disclosed embodiments are considered in all respects to be illustrative and not restrictive. The scope of the invention is indicated by the appended claims, rather than the foregoing description, and all changes that come within the meaning and range of equivalents thereof are intended to be embraced thereby.

1. A method for sharing a plurality of interrupt inputs associated with a processor among a plurality of interrupt sources, comprising the steps of:
mapping each of the plurality of interrupt sources to each of the plurality of interrupt inputs; and
selectively enabling interrupt requests from each of the plurality of interrupt sources to one or more of the plurality of interrupt inputs.

2. The method of claim 1, wherein the step of selectively enabling comprises:
determining a value of control bits respectively associated with each mapped interrupt source/interrupt input combination; and
selectively enabling interrupt requests between the mapped interrupt source/interrupt input combinations according to the respective control bit values.

3. The method of claim 1, wherein the step of selectively enabling comprises:
a) determining a value of a control bit associated with a mapped interrupt source/interrupt input combination;
b) selectively enabling interrupt requests between the mapped interrupt source/interrupt input combination according to the associated control bit value; and
c) repeating steps a and b until control bit values for all mapped interrupt source/interrupt input combinations are determined and enabled/disabled accordingly.

4. The method of claim 2, further comprising setting the control bit values according to user preferences.

5. The method of claim 4, further comprising dynamically modifying the control bit values according to user preferences.

6. The method of claim 2, further comprising defining the control bit values according to system requirements, said system comprising the processor, at least one interrupt source, and at least one interrupt input.

7. A system for sharing a plurality of interrupt inputs associated with a processor among a plurality of interrupt sources, comprising:
logic that maps each of the plurality of interrupt sources to each of the plurality of interrupt inputs; and
logic that selectively enables interrupt requests from each of the plurality of interrupt sources to one or more of the plurality of interrupt inputs.

8. The system of claim 7, wherein the logic that selectively enables comprises:
logic that determines a value of control bits respectively associated with each mapped interrupt source/interrupt input combination; and
logic that selectively enables interrupt requests between the mapped interrupt source/interrupt input combinations according to the respective control bit values.

9. The system of claim 7, wherein the logic that selectively enables comprises:
logic that determines a value of a control bit associated with a mapped interrupt source/interrupt input combination;
logic that selectively enables interrupt requests between the mapped interrupt source/interrupt input combination according to the associated control bit value; and
logic that advances the logic that determines and the logic that selectively enables until control bit values for all mapped interrupt source I interrupt input combinations are determined and enabled/disabled accordingly.

10. The system of claim 8, further comprising logic that sets the control bit values according to user preferences.

11. The system of claim 10, further comprising logic that dynamically modifies the control bit values according to user preferences.

12. The system of claim 8, further comprising logic that defines the control bit values according to system requirements, said system comprising the processor, at least one interrupt source, and at least one interrupt input.

13. The system of claim 8, wherein the logic that selectively enables comprises, for each mapped interrupt source/interrupt input combination, a logical AND for ANDing each interrupt source with a respective control bit value.

14. A system for sharing a plurality of interrupt inputs associated with a processor among a plurality of interrupt sources, comprising:
for each interrupt input:
a plurality of logical ANDs, each corresponding to an interrupt source, the corresponding interrupt source providing an interrupt request signal to the corresponding logical AND to interrupt the processor;
a plurality of control bits each corresponding to an interrupt source and each respectively providing a control bit value to the corresponding logical AND, wherein, based on the control bit value, a corresponding interrupt request signal is provided at an output of the corresponding logical AND;
a logical OR arranged to indicate, to the interrupt input, the presence of a corresponding interrupt request signal from at least one output of the plurality of logical ANDs.

15. The system of claim 14, further comprising a register for storing the control bit values.

16. The system of claim 14, further comprising logic that sets the control bit values according to user preferences.

17. The system of claim 16, further comprising logic that dynamically modifies the control bit values according to user preferences.

18. The system of claim 14, further comprising logic that defines the control bit values according to system requirements, said system comprising the processor, at least one interrupt source, and at least one interrupt input.

19. The system of claim 14, wherein the processor is part of a microcontroller unit.

20. The system of claim 14, wherein the number of interrupt sources is greater than the number of interrupt inputs.
